(19) United States
(12) Patent Application Publication
(10) Pub. No.: US 2024/0111274 A1
(43) Pub. Date: Apr. 4, 2024

(54) Hierarchical Optimization of Modular Technical Systems

(71) Applicant: Siemens Aktiengesellschaft, Muenchen (DE)

(72) Inventor: Daniel LABISCH, Karlsruhe (DE)

(21) Appl. No.: 17/768,653

(22) PCT Filed: Oct. 7, 2020
(86) PCT No.: PCT/EP2020/078160

§ 371 Date: Apr. 13, 2022

(30) Foreign Application Priority Data
Oct. 14, 2019 (EP) 19203010

(51) Int. Cl. G05B 19/418

(52) U.S. Cl. CPC G05B 19/41845; G05B 2219/32324; G05B 2219/35029

(57) ABSTRACT

A computer-implemented method for operating a modular technical system that includes a technical module and a module-spanning management system, where the method includes transmitting constraints and targets of an operation of the technical system from the management system to either the technical module or a corresponding computer-implemented representation of the technical module; determining, via the at least one technical module or the corresponding computer-implemented representation of the technical module, an optimal operating point of the at least one technical module based on the previously received constraints and targets; determining at least one performance indicator, relating to the optimal operating point, of the corresponding technical module and transmitting the at least one performance indicator from the technical module or the corresponding computer-implemented representation to the management system, and orchestrating the technical module via the management system by incorporating the at least one performance indicator to operate the modular technical system.

### CROSS-REFERENCE TO RELATED APPLICATIONS

This is a U.S. national stage of application No. PCT/EP2020/078160 filed 7 Oct. 2020. Priority is claimed on European Application No. 19203010.4 filed 14 Oct. 2019, the content of which is incorporated herein by reference in its entirety.

### BACKGROUND OF THE INVENTION

### 1. Field of the Invention

The invention relates to a technical module, a computer-implemented representation of the technical module and to a computer-implemented method for operating a modular technical installation.

### 2. Detailed Description of the Exemplary Embodiments

Modular process engineering installations comprise a number of technical modules, which are connected to one another and interact via both process engineering and also automation technology. In this way, the modules can originate from different manufacturers and can also be automated differently. In certain respects, modules represent self-contained units that can fulfill certain tasks. To this end, modules provide services that are described via Modular Type Package (MTP), for instance.

Here a service represents a task or a service that can be executed by a module. As a function of the task, a service generally requires a configuration via parameters, which are required to fulfill the task. For instance, a service “heating” could require the parameter target temperature. The service is configured, parameterized and started by the automation of the overall system (process control level, PFE, or the control system).

Each production installation is to fulfill its task as optimally as possible, where there is no universal definition of this optimal fulfillment. The important key performance indicators (KPIs) or production targets are, for instance, the product quality, the quantity produced or production rate and the costs involved in production. The product quality can consist here of several variables.

For a monolithic (i.e., non modular) installation, which is configured for a long operating phase, a non-recurring optimization of the automation and the operation mode is generally worthwhile. However, the flexibility produced as a result of a modular installation results in any change also changing the optimization problem and a non-recurring optimization no longer being sustainable. Frequent optimizations are, however, associated with effort and therefore with cost and are possibly no longer worthwhile. The advantage of the flexibility as a result of modularity is therefore disadvantageous for the optimization.

### SUMMARY OF THE INVENTION

It is an object of the present invention to provide a computer-implemented method for operating a modular technical installation, which reduces the complexity of the optimization of a modular technical installation.

This and other objects and advantages are achieved in accordance with the invention by a computer-implemented method for operating a modular technical installation that comprises at least one technical module and a control system that encompasses all modules. The inventive method comprises a) transmitting boundary conditions and targets of an operation of the technical installation from the control system to the at least one technical module or to a computer-implemented representation of the technical module; b) determining an optimal working point of the at least one technical module as a function of the previously received boundary conditions and targets via the technical module itself or via the computer-implemented representation of the technical module; c) determining at least one performance indicator of the technical module that forms part of the optimal working point and transferring the at least one performance indicator from the technical module or the computer-implemented representation of the technical module to the control system; and d) orchestrating the at least one technical module through the control system by including the at least one performance indicator, in order to operate the modular technical installation.

The modular technical installation can be an installation from the process industry, such as a chemical, pharmaceutical or petrochemical installation, or an installation from the food and beverage industry. This also encompasses any installations from the production industry, factories, in which, for example, automobiles or goods of all kinds are produced. Modular technical installations that are suitable for implementing the method in accordance with the invention can also come from the power generation sector. The term “technical installation” also encompasses wind turbines, solar installations or power generation plants.

These installations each have a control system or at least a computer-aided module for the open-loop and closed-loop control of the running process or production. Moreover, the modular technical installation has a plurality of technical modules, which can be combined with one another.

In the present context, a control system is understood to mean a computer-aided technical system that comprises functionalities for representing, operating and controlling a technical system, such as a manufacturing or production installation. Here, the control system comprises sensors for determining measurement values, as well as various actuators. Additionally, the control system comprises “process-oriented components”, which serve to activate the actuators or sensors. Furthermore, the control system has inter alia components for visualizing the process installation and for engineering. The term control system is additionally intended to also encompass further computing units for more complex closed-loop controls and systems for data storage and data processing.

A technical module is understood to mean a self-contained technical unit that can be integrated into a higher-level control level. One such technical module may, for example, be an amalgamation of a plurality of measuring points or a larger installation part of an industrial installation. The technical module does not have to originate from the field of industrial installations, however, but rather may also be a motor module of an automotive, a ship or the like, for example.

A computer-implemented representation of a technical module is, for instance, an “application” or “app”, which is executed on a computer that is separated (spatially) from the technical module or in a cloud environment. The computer-implemented representation is a type of digital twin of the technical module. All information that is required to characterize the behavior of the technical module is contained therein. If, in accordance with the invention, boundary conditions and targets are transmitted from the control system to the computer-implemented (digital) representation and from there in turn the performance indicators are received, then it makes no difference to the control system whether it interacts with the actual (physical) technical module or with its computer-implemented (digital) representation.

Within the scope of the inventive method, boundary conditions and targets of the operation of the technical installation are transmitted from the control system to the plurality of technical modules or to their computer-implemented representations. Here, boundary conditions can be, for instance, temperature limit values, material properties, physical boundary conditions or also a current electricity tariff. The operation targets can be, for instance, production quantities and production types.

The optimal working point depends on the boundary conditions transmitted to the technical module or the computer-implemented representation, which cannot be influenced in the technical module. In the technical (overall) installation, these variables are, however, known or can be measured. These are provided as information to the technical module or to the computer-implemented representation by the control system. Based on the boundary conditions and the targets of an operation of the technical installation, each technical module can be operated optimally. For instance, depending on the situation there may be other quality requirements. The quantity and production time available can also vary. Accordingly, the production costs also vary.

The optimization at module level can occur in a different manner. For simple tasks of the technical modules, algebraic equations, characteristic curves, maps or heuristics are sufficient. More complex tasks require possibly the use of simulation modules for optimization. The results of the optimization, i.e., the mode of operation that is optimal for the respective technical module taking into account the predefined boundary conditions and targets are determined by the technical module or the computer-implemented representation and fed back in the form of a performance indicator to the control system as an overlaid orchestration entity.

With the optimization, a single performance indicator can be determined as a result, it need not, however, be a single performance indicator. Instead, a plurality of performance indicators can also be determined within the scope of the inventive method. For instance, this can also involve the indicators “costs”, “duration” or “quality”. These can in turn depend on one or more parameters.

With predefined boundary conditions and targets, there can be degrees of freedom in the operation of the respective technical modules, which influence significant targets of the operation of the technical installation (e.g., production duration, costs, quality).

Here, the result of the optimization, the performance indicator or the performance indicators, is passed to the control system in the form of maps relating to the free parameters. In a special case of a degree of freedom, characteristic curves of the observed boundary conditions and targets result.

The orchestration of the technical modules is then implemented above the technical modules, at the level of the control system of the technical installation. This can contain an overlaid optimization. Here, the information obtained from the technical modules or their computer-implemented representation is used to achieve an operation which is optimal to the technical installation.

One particularly important advantage of the inventive method lies in the complexity of the respective technical modules playing only a subordinate or negligible role in the optimization. The disclosed method enables the flexibility enabled by the modularization no longer to be considered to be a disadvantage for the optimization, but instead skillfully uses the new possibilities developed in the process. With the configuration or optimization of each technical module, only the (manageable) behavior of this technical module must be observed. Variables (boundary conditions, targets of the operation) that are unknown to the technical module are provided herefor to the technical modules or their computer-implemented representation. It is insignificant here whether the optimization is now implemented in a simulation-based, algebraic or heuristic manner.

It is also an object of the invention to provide a technical module that is configured to a) receive boundary conditions and targets of an operation of a technical installation from a control system of the technical installation, b) determine an optimum working point as a function of the previously received boundary conditions and targets themselves, and c) determine at least one performance indicator of the technical module which forms part of the optimal working point and to transmit the at least one performance indicator to the control system for further processing.

It is also an object of the invention to provide a computer-implemented representation of a technical module that is configured to a) receive boundary conditions and targets of an operation of a technical installation from a control system of the technical installation, b) determine an optimum working point as a function of the previously received boundary conditions and targets themselves, and c) determine at least one performance indicator of the technical module that forms part of the optimal working point and to transmit the at least one performance indicator to the control system for further processing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which these are achieved will now be made more clearly and distinctly intelligible in conjunction with the following description of the exemplary embodiment, which will be described in detail making reference to the drawings, in which:

FIG. 1 is a schematic block diagram of a control system of a technical installation in accordance with the invention; and

FIG. 2 is a flowchart of the computer-implemented method in accordance with the invention.

### DETAILED DESCRIPTION OF THE EXEMPLARY EMBODIMENTS

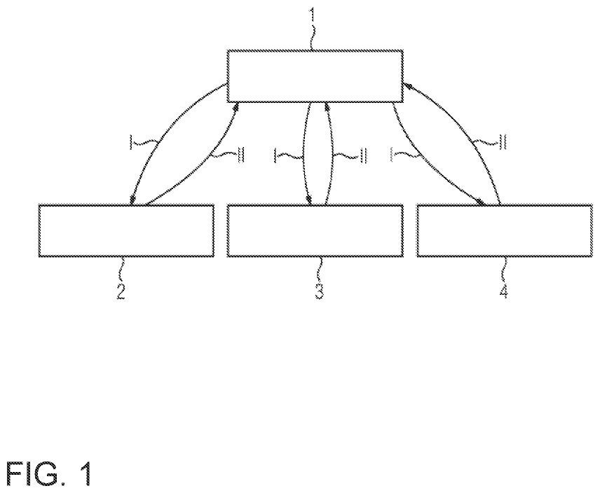

FIG. 1 shows a schematic representation of a control system 1 of a technical installation embodied as a process installation and a first technical module 2, a second technical module 3 and a third technical module 4. The first technical module 2, the second technical module 3 and the third technical module 4 have direct contact with the control system 1.

The first technical module 2 comprises a reaction container, into which citric acid, sodium citrate and sodium sulphate can be added in an aqueous solution in order to change the pH value, density and conductivity. A stirrer is located in the reaction container for the purpose of ensuring the necessary mixing. Only the pH value and the dosing of citric acid is then observed. Within the scope of a modular automation of the process installation, the first technical module 2 offers the following service:
Set pH value; set predefined pH value parameters: pH value, stirrer speed, quantity

The second technical module 3 comprises a fermenter, which can be heated and cooled via a casing. Fermentation processes typically occur therein. The second technical module 3 offers the following service:
Fermentation: Heating-up (15 min), maintain target temperature to be predefined (duration dependent on the quantity and target temperature), cooling down (20 min).
Parameters: target temperature, quantity, pH value

In the third technical module 4 the previously produced liquid is filled. The third technical module 4 offers the following service:
Filling the product at 1 l/min
Parameters: Quantity

The three technical modules 2, 3, 4 are connected to one another via an infrastructure, not shown in the figure, such that any exchange of liquids can occur between the technical modules 2, 3, 4.

One target of the operation of the process installation is the production and filling of three batches:
C1: 30 l unfermented product with pH value 2; completion in 1.5 hrs,
C2: 30 l unfermented product with pH value 3; completion in 2 h
C3: 30 l unfermented product with pH value 4; completion in 4 h

The batches C1, C2, C3 should be produced and filled within the specified completion times.

In the present case, the quantities and pH values are fixedly predefined and can be provided in advance as information to the technical modules 2, 3, 4 by the control system 1. This means that each technical module 2, 3, 4 is optimized per se and the dependency of a performance indicator on stirrer speed or target temperature is determined.

For the first technical module 2, it is assumed that tables were stored by the manufacturer, to determine how long, depending on quantity, pH value and stirrer speed, stirring has to be performed. Support points for the characteristic curves with the remaining dependency stirrer speed are determined herefrom as a performance indicator.

It is assumed for the second technical module 3 that a process engineering simulation model is available. The simulation is performed with the now known parameters quantity and pH value for various temperature target values and the results as support points are moved into a characteristic curve as a performance indicator.

In the third technical module 4, the algebraic equation T=R*V is stored with the filling rate R=1 1/min, which can be evaluated for V=301 directly at T=30 min.

The configured services that are made available to the control system 1 as performance indicators therefore read:
Set pH value (V=301, pH value=2) T=40 min-2 min/5%*(N-50%); K=1€/50%*(N-50%)+4€; Q=1; in each case for stirrer speed (N) in the region of 50%-100%
Set pH value(V=301, pH value=3) T=60 min-3 min/5%*(N-50%); K=1€/50%*(N-50%)+6€; Q=1; in each case for stirrer speed (N) in the region of 50%-100%
Set pH value (V=301, pH value=4) T=50 min-1 min/2%*(N-50%); K=1€/50%*(N-50%)+5€; Q=1; in each case for stirrer speed (N) in the region of 50%-100%
Fermentation (V=301, pH value=4) T=3 h-1 h/10° C.*(Temp-80° C.); K=1€/1° C.*(Temp-80° C.)+20€; Q=1-1/100° C.*(Temp-80° C.); in each case for target temperature (Temp) in the region of 80-90° C.
Filling (301) T=30 min; K=2€; Q=1; no degrees of freedom

Here, T represents a duration, K represents production costs and Q represents a production quality. This involves the performance indicators that are made available to the overlaid control system 1.

The optimized orchestration of the services can now occur in an overlaid manner. The production targets are to be retained, here. The minimum quality amounts to 0.95 and the costs should be minimized, i.e., the quality criterion to be minimized is J=K.

The optimization problem described here contains binary optimization parameters (in which sequence the services are started) and continuous (the described degrees of freedom). Redundancies in production are not available here. In general, any mixed-integer nonlinear programming (MINLP) methods can be used, for instance.

In this case, the dependencies and the quality criterion are linear, so that the solution is mathematically simple. Here the following parameterizations of the services result in the sequence shown:
0:00 h 1st module: Set pH value (V=301, pH value=4, N=90%)
0:30 h 2nd module: Fermentation (V=301, pH value=4, Temp 80° C.)
0:30 h 1st module: Set pH value (V=301, pH value=2, N=75%)
1:00 h 3rd module: Filling (V=301, pH value=2)
1:00 h 1st module: Set pH value (V=301, pH value=3, N=100%)
1:30 h 3rd module: Filling (V=301, pH value=3)
3:30 h 3rd module: Filling (V=301, pH value=4).

The planned completion times are therefore fulfilled exactly. At the same time, the fermentation is performed with the lowest target temperature, which results in minimal costs and maximum quality. When the pH values are set, the stirrer speeds can be reduced to further reduce the costs with the available time. Overall, the total costs result in 5.80€+20€+4.50€+2€+7€+2€+2€=43.30 €.

If there is no optimized orchestration in the control system 1, but instead only prioritized with the completion times (sequence C1, C2, C3), then C1 and C2 are finished promptly, the completion of C3 is delayed, however, by approx. 1 h, which is not known at all in advance without the optimization of the services at module level and the provision of the characteristic maps.

Assuming that the time problem is nevertheless basically identified in advance, each service can be selected according to the minimum runtime which produces costs of 6€+30€+5€+2€+7€+2€+2€=54 €.

However, C3 is completed 45 minutes too late. At the same time, the costs increase compared with the optimized solution according to the inventive method by 25%.

Although the invention has been illustrated and described in greater detail with the preferred exemplary embodiment and the figures, the invention is not restricted by the examples disclosed and other variations can be derived therefrom by the person skilled in the art without departing from the protective scope of the invention.

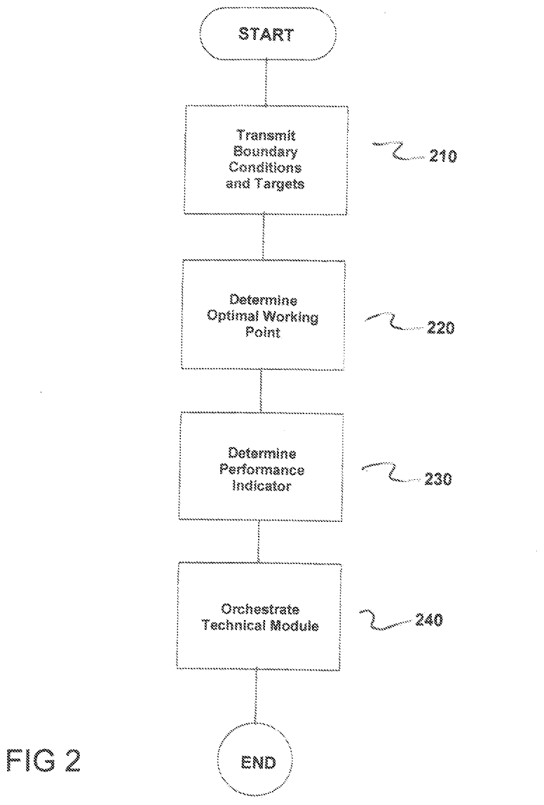

FIG. 2 is a flowchart of a computer-implemented method for operating a modular technical installation which comprises at least one technical module 2, 3, 4 and a control system (1) which encompasses all modules.

The method comprises a) transmitting boundary conditions and targets of an operation of the technical installation from the control system 1 to either one the at least one technical module 2, 3, 4 or a respective computer-implemented representation of the technical module 2, 3, 4, as indicated in step 210.

Next, b) determining an optimal working point of the at least one technical module 2, 3, 4 is determined as a function of a previously received boundary conditions and targets by either the at least one technical module 2, 3, 4 or the respective computer-implemented representation of the technical module 2, 3, 4, as indicated in step 220.

Next, c) at least one performance indicator of the respective technical module 2, 3, 4 that forms part of the determined optimal working point is determined and the at least one performance indicator is transferred from either the at least one technical module 2, 3, 4 or the respective computer implemented representation to the control system 1, as indicated in step 230.

Next, d) the at least one technical module 2, 3, 4 is orchestrated through the control system by including the at least one performance indicator to operate the modular technical installation, as indicated in step 240.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-3. (canceled)

4. A computer-implemented method for operating a modular technical installation which comprises at least one technical module and a control system which encompasses all modules, the method comprising:
a) transmitting boundary conditions and targets of an operation of the technical installation from the control system to one of (i) the at least one technical module and (ii) a respective computer-implemented representation of the technical module;
b) determining an optimal working point of the at least one technical module as a function of a previously received boundary conditions and targets by one of (i) the at least one technical module and (ii) the respective computer-implemented representation of the technical module;
c) determining at least one performance indicator of the respective technical module which forms part of the determined optimal working point and transferring the at least one performance indicator from at least one of (i) the at least one technical module and (ii) a respective computer-implemented representation to the control system; and
d) orchestrating the at least one technical module through the control system by including the at least one performance indicator to operate the modular technical installation.

5. A technical module, wherein the technical module is configured to:
a) receive boundary conditions and targets an operation of a technical installation from a control system of the technical installation;
b) determine an optimum working point as a function of previously received boundary conditions and targets themselves; and
c) determine at least one performance indicator of the technical module which forms part of the determined optimal working point and transmit the at least one performance indicator to the control system for further processing.

6. A computer-implemented representation of a technical module which is configured to:
a) receive boundary conditions and targets of an operation of a technical installation from a control system of a technical installation;
b) determine an optimum working point as a function of previously received boundary conditions and targets themselves; and
c) determine at least one performance indicator of the technical module which forms part of the determined optimal working point and transmit the at least one performance indicator to the control system for further processing.
